(19) United States
(12) Patent Application Publication
(10) Pub. No.: US 2021/0333664 A1
(43) Pub. Date: Oct. 28, 2021

(54) DISPLAY PANEL, DRIVING METHOD AND DRIVING CIRCUIT

(71) Applicant: HKC CORPORATION LIMITED, Shenzhen (CN)

(72) Inventor: Jianfeng SHAN, Shenzhen (CN)

(21) Appl. No.: 16/461,370

(22) PCT Filed: Feb. 20, 2019
(86) PCT No.: PCT/CN2019/075518

§ 371 Date: May 16, 2019

(30) Foreign Application Priority Data
Jan. 30, 2019 (CN) 201910089178.0

(51) Int. Cl. G02F 1/1362; G09G 3/36

(52) U.S. Cl. CPC G02F 1/136213; G09G 2320/0247; G09G 3/3677; G02F 1/136286

(57) ABSTRACT

The present application discloses a display panel, a driving method and a driving circuit. The display panel includes a plurality of data lines, a plurality of gate lines, the gate lines and the data lines being intersected with each other; the display panel further includes a plurality of pixels, respectively driven by corresponding gate lines and data lines, each pixel includes a corresponding pixel electrode. The pixel electrode of the pixel overlaps with adjacent another gate line to form an overlap region.

The present application claims priority to the Chinese Patent Application No. CN201910089178.0, filed with the Chinese Patent Office on Jan. 30, 2019, and entitled “DISPLAY PANEL, DRIVING METHOD AND DRIVING CIRCUIT”, which is incorporated herein by reference in its entirety.

### TECHNICAL FIELD

The present application relates to the technical field of display, and in particular, to a display panel, a driving method and a driving circuit.

### BACKGROUND

The statements herein merely provide background information related to the present application and do not necessarily constitute the prior art.

With the development and advancement of technologies, flat panel displays have become mainstream products of displays due to their thin bodies, power-saving and low radiation, and thus have been widely used. The flat panel displays include Thin Film Transistor-Liquid Crystal Displays (TFT-LCDs), Organic Light-Emitting Diode (OLED) displays, etc. The TFT-LCDs control the rotation direction of liquid crystal molecules to refract light of a backlight module to generate a picture, and has many advantages such as thin bodies, power-saving and no radiation. Moreover, the OLED displays are prepared by OLEDs, and have many advantages such as self-illumination, short response time, high definition and contrast, and can realize flexible display and large-area full-color display.

In the use of a general liquid crystal display, the definition and stability of the display picture are often affected by the driving voltage, resulting in a decrease in definition, a decrease in the stability of the picture, and frequent flickers.

### SUMMARY

The present application provides a display panel, a driving method and a driving circuit for reducing or even eliminating flicker phenomenon of the display panel caused by redistribution of a liquid crystal capacitance and a storage capacitance by a parasitic capacitance.

To achieve the foregoing objective, the present application provides a display panel, including a plurality of data lines, a plurality of gate lines, and a plurality of pixels formed by intersecting the gate lines with the data lines; each pixel is separately driven by corresponding data line and gate line, and each pixel includes a corresponding pixel electrode; where the pixel electrode of the pixel overlaps with adjacent another gate line to form an overlap region.

Optionally, the gate lines include main gate lines and auxiliary gate lines conducted to each other, the main gate lines are intersected with the data lines.

Optionally, the auxiliary gate lines and the data lines are arranged in parallel.

Optionally, a same gate line is connected to two adjacent pixels to form a pixel group, and the pixel group includes a first pixel and a second pixel connected to different data lines; where a pixel electrode of the first pixel of the pixel group overlaps with a previous gate line to form a first overlap region, and a pixel electrode of the second pixel of the pixel group overlaps with a next gate line to form a second overlap region.

Optionally, the auxiliary gate lines include first auxiliary gate lines and second auxiliary gate lines, the first auxiliary gate lines and the pixel electrode of the second pixel corresponding to the previous gate line form a first overlap region, and the second auxiliary gate lines and the pixel electrode of the first pixel corresponding to the next gate line form a second overlap region.

Optionally, the same data line is connected to two adjacent pixels to form a pixel group, and the pixel group includes a first pixel and a second pixel connected to different gate lines; where the pixel electrode of the first pixel of the pixel group overlaps with the previous gate line to form a first overlap region, and the pixel electrode of the second pixel of the pixel group overlaps with the next gate line to form a second overlap region.

Optionally, the same data line is connected to two adjacent pixels to form a pixel group, and the pixel group includes a first pixel and a second pixel connected to different gate lines; gate lines connected to the first pixels are first gate lines, the first gate lines includes first main gate lines and first auxiliary gate lines, gate lines connected to the second pixels are second gate lines, and the second gate lines include second main gate lines and second auxiliary gate lines; the first auxiliary gate lines and the pixel electrode of the second pixel corresponding to the second main gate lines form a first overlap region, and the second auxiliary gate lines and the pixel electrode of the first pixel corresponding to the first main gate lines form a second overlap region.

Optionally, a first safety distance is arranged both between the auxiliary gate line and the pixel electrode of the first pixel corresponding to the current main gate line, and between the auxiliary gate line and the pixel electrode of the second pixel corresponding to the previous main gate line.

Optionally, a second safety distance is arranged between the auxiliary gate line and corresponding data line.

The present application further discloses a driving method, applied to any display panel as stated above, and the display panel includes a plurality of pixels formed by intersecting a plurality of data lines with a plurality of gate lines; the driving method includes a step of outputting a gate driving signal to a corresponding gate line of the display panel; where a signal period of the gate driving signal includes a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down time and the second pull-down time; and a voltage value of the second low level is less than a voltage value of the first low level.

Optionally, the first pull-down time is before the open time, and a signal period of the gate driving signal further includes a second pull-down time after the open time; the gate driving signal is in a third low level within the second pull-down time, and a voltage value of the third low level is less than the voltage value of the first low level.

Optionally, the first pull-down time and the open time are equal in duration, and when a gate driving signal of a previous gate line corresponds to the open time, a gate driving signal of a current gate line corresponds to the first pull-down time.

Optionally, the open time and the second pull-down time are equal in duration, and when the gate driving signal of the previous gate line corresponds to the second pull-down time, the gate driving signal of the current gate line corresponds to the open time.

Optionally, the voltage value of the second low level is equal to the voltage value of the third low level.

Optionally, the each pixel includes a pixel electrode, a same gate line is connected to two adjacent pixels to form a pixel group, and the pixel group includes a first pixel and a second pixel connected to different data lines; where a pixel electrode of the first pixel of the pixel group overlaps with the previous gate line to form a first overlap region, the area of the first overlap region is S1, a storage capacitance formed by overlapping the first overlap region of the first pixel with the previous gate line is Cst1, a pixel capacitance of the first pixel is Clc1, and a parasitic capacitance formed by the pixel electrode of the first pixel and the current gate line is Cgs1; the voltage values of the first low level and the third low level are V′GL, the voltage value of the high level is VGH, and the voltage value of the second low level is VGL;

Cst1=(VGH−VGL)*Cgs1/(VGL−V′GL).

Optionally, the each pixel includes a pixel electrode, a same gate line is connected to two adjacent pixels to form a pixel group, and the pixel group includes a first pixel and a second pixel connected to different data lines; a pixel electrode of the second pixel of the pixel group overlaps with a next gate line to form a second overlap region, the area of the second overlap region is S2, a storage capacitance formed by overlapping the second overlap region of the second pixel with the next gate line is Cst2, a pixel capacitance of the second pixel is Clc2, and a parasitic capacitance formed by the pixel electrode of the second pixel and the current gate line is Cgs2; the voltage values of the first low level and the third low level are V′GL, the voltage value of the high level is VGH, and the voltage value of the second low level is VGL;

Cst2=(VGH−VGL)*Cgs2/(VGL−V′GL).

The present application further discloses a driving circuit for driving any display panel as stated above, and the driving circuit includes: a gate driving circuit configured to output a gate driving signal to a corresponding gate line of the display panel; where a signal period of the gate driving signal includes a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down time and the second pull-down time; and a voltage value of the second low level is less than a voltage value of the first low level.

Optionally, the first pull-down time and the open time are equal in duration, and when a gate driving signal of a previous gate line corresponds to the open time, a gate driving signal of a current gate line corresponds to the first pull-down time.

Optionally, the open time and the second pull-down time are equal in duration, and when the gate driving signal of the previous gate line corresponds to the second pull-down time, the gate driving signal of the current gate line corresponds to the open time.

Compared to the solution that a pixel electrode of the pixel corresponding to the current gate line and the current gate line form a storage capacitance, in the present application, a plurality of pixels is formed by intersecting a plurality of data lines with a plurality of gate lines, each pixel includes a pixel electrode, and the pixel electrode and the gate lines are easy to form a parasitic capacitance. In order to avoid a large influence of the parasitic capacitance, we increase the storage capacitance formed by the pixel electrode and the gate lines; the pixel electrode corresponding to the current gate line overlaps with adjacent another gate line to form an overlap region; and increasing the storage capacitance can reduce or even eliminate the flicker phenomenon of the display panel caused by the redistribution of the liquid crystal capacitance and the storage capacitance by the parasitic capacitance.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a pixel structure according to an embodiment of the present application;

FIG. 2 is a schematic diagram of a pixel structure circuit according to an embodiment of the present application;

FIG. 3 is a schematic diagram of a pixel structure according to an embodiment of the present application;

FIG. 4 is a schematic diagram of a pixel structure according to another embodiment of the present application;

FIG. 5 is schematic diagram of a pixel structure according to another embodiment of the present application;

FIG. 6 is a schematic diagram of a driving waveform according to another embodiment of the present application;

FIG. 7 is a schematic diagram of a driving circuit according to another embodiment of the present application; and

FIG. 8 is a schematic diagram of a display device according to another embodiment of the present application.

### DETAILED DESCRIPTION

It should be understood that the terms used herein and the specific structure and function details disclosed herein are merely representative, and are intended to describe specific embodiments. However, the present application can be specifically embodied in many alternative forms, and should not be interpreted to be limited to the embodiments described herein.

In the description of the present application, the terms such as “first” and “second” are merely for a descriptive purpose, and cannot be understood as indicating a relative importance, or implicitly indicating the number of the indicated technical features. Hence, the features defined by “first” and “second” can explicitly or implicitly include one or more features, and “a plurality of” means two or more, unless otherwise stated. The term “comprise” and any variations thereof are intended to cover a non-exclusive inclusion, and the presence or addition of one or more other features, integers, steps, operations, elements, components and/or combinations thereof may be possible.

In addition, orientation or position relationships indicated by the terms “center”, “transversal”, “upper”, “less”, “left”, “right”, “vertical”, “horizontal”, “top”, “bottom”, “inner”, “outer”, etc. are based on the orientation or relative position relationships as shown in the drawings, for ease of the description of the present application and simplifying the description only, rather than indicating that the indicated device or element must have a particular orientation or be constructed and operated in a particular orientation. Therefore, these terms should not be understood as a limitation to the present application.

In addition, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by a person of ordinary skill in the art according to specific circumstances.

The present application is further described below with reference to the accompanying drawings and optional embodiments.

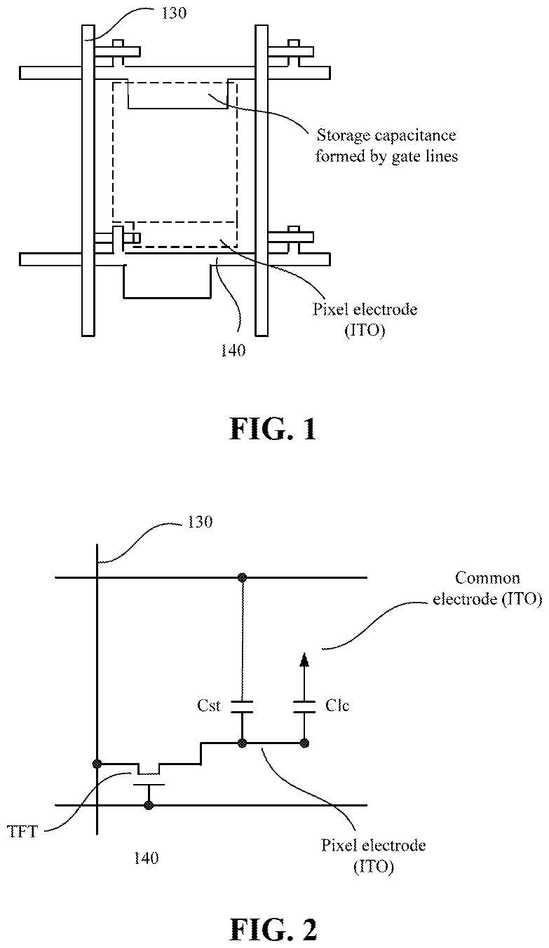

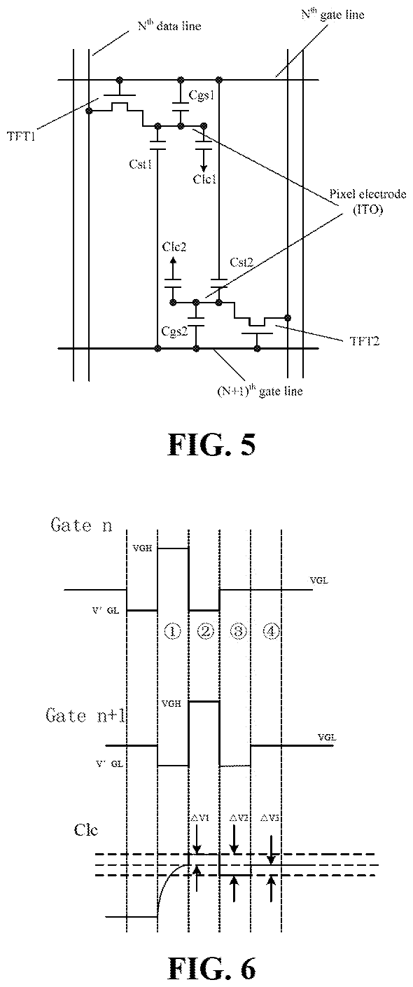

As shown in FIGS. 1 to 5, an embodiment of the present application discloses a display panel 110, including a plurality of data lines 130, a plurality of gate lines 140, and a plurality of pixels 150; the gate lines 140 are intersected with the data lines 130; each of the plurality of pixels 150 formed by the intersection is separately driven by corresponding data line 130 and gate line 140, and each pixel 150 includes a corresponding pixel electrode; where the pixel electrode of the pixel 150 overlaps with adjacent another gate line 140 to form an overlap region.

As shown in FIG. 1, a current gate line 140 corresponds to the pixel 150, a gate line 140 adjacent to the current gate line 140 is called another gate line 140, and a pixel electrode of the pixel 150 overlaps with another gate line 140 to form an overlap region. In this solution, a plurality of data lines 130 and a plurality of gate lines 140 are intersected with each other to form a plurality of pixels 150; each pixel 150 includes a pixel electrode; the pixel electrode and the gate lines 140 are easy to form a parasitic capacitance. In order to avoid a large influence of the parasitic capacitance, we increase the storage capacitance formed by the pixel electrode and the gate lines 140; with reference to a circuit as shown in FIG. 2, the pixel electrode corresponding to the current gate line 140 overlaps with adjacent another gate line 140 to form an overlap region; and increasing the storage capacitance can reduce or even eliminate the flicker phenomenon of the display panel 110 caused by the redistribution of the liquid crystal capacitance and the storage capacitance by the parasitic capacitance.

In one or more embodiments, the gate lines 140 include main gate lines 141 and auxiliary gate lines 142 conducted to each other, the main gate lines 141 are intersected with the data lines 130, and the auxiliary gate lines 142 and the data lines 130 are arranged in parallel. In this solution, the gate lines 140 are divided into main gate lines 141 and auxiliary gate lines 142, the main gate lines 141 are intersected with the data lines 130, the increased auxiliary gate lines 142 and the data lines 130 are arranged in parallel, and the main gate lines 141 and auxiliary gate lines 142 are conducted to each other to reduce the influence of the data lines 130 to the voltage of the pixel electrode to cause so-called crosstalk to affect the picture quality, and to reduce the influence of the parasitic capacitance generated by the main gate line 141 and the pixel electrode on the display flicker of the display panel 110.

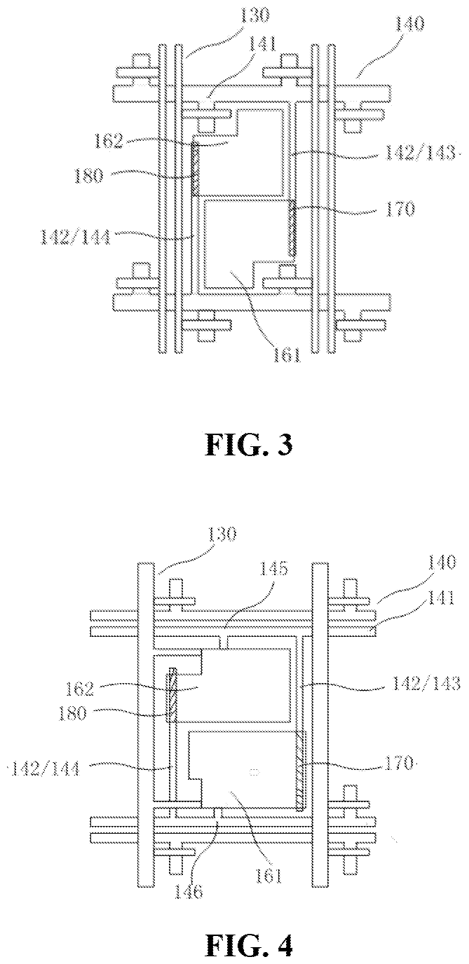

In one or more embodiments, as shown in FIG. 3, a same gate line 140 is connected to two adjacent pixels 150 to form a pixel group 160, and the pixel group 160 includes a first pixel 161 and a second pixel 162 connected to different data lines 130; where a pixel electrode of the first pixel 161 of the pixel group 160 overlaps with a previous gate line 140 to form a first overlap region 170, and a pixel electrode of the second pixel 162 of the pixel group 160 overlaps with a next gate line 140 to form a second overlap region 180. In this solution, two pixels 150 in the pixel group 160 respectively correspond to different data lines 130, so as to ensure the data driving voltage of each pixel 150 and prevent decrease of the data voltage caused by the load of the pixel electrode itself; in addition, the pixel electrodes of different pixels 150 in the pixel group 160 respectively overlap with the previous gate line 140 and the next gate line 140 to form two different storage capacitances; increasing the storage capacitance can reduce the influence of the parasitic capacitance generated by the pixel electrode and the gate line 140, thereby reducing or even eliminating the flicker problem of the display panel 110 caused by the redistribution of the liquid crystal capacitance and the storage capacitance by the parasitic capacitance, and moreover, the aperture rate can be reduced, and the penetration rate of the liquid crystal molecules can be improved, so as to achieve large view-angle color offset.

In one or more embodiments, as shown in FIG. 3, the auxiliary gate lines 142 include first auxiliary gate lines 144 and second auxiliary gate lines 143, the first auxiliary gate lines 144 and the pixel electrode of the second pixel 162 corresponding to the previous gate line 140 form a second overlap region 180, and the second auxiliary gate lines 143 and the pixel electrode of the first pixel 161 corresponding to the next gate line 140 form a first overlap region 170. In this solution, the auxiliary gate lines 142 extending from the main gate lines 141 and the pixel group 160 form an overlap region; the auxiliary gate lines 142 may have an effect of shielding an electric field, reducing the occurrence of the electric field between the pixel electrode and the data line 130.

As shown in FIG. 4, the same data line 130 is connected to two adjacent pixels 150 to form a pixel group 160, and the pixel group 160 includes a first pixel 161 and a second pixel 162 connected to different gate lines 140; where the pixel electrode of the first pixel 161 of the pixel group 160 overlaps with the previous gate line 140 to form a first overlap region 170, and the pixel electrode of the second pixel 162 of the pixel group 160 overlaps with the next gate line 140 to form a second overlap region 180. The area of the first overlap region is S1, a storage capacitance formed by overlapping the first overlap region 170 of the first pixel 161 with the previous gate line 140 is Cst1, a pixel capacitance of the first pixel 161 is Clc1, and a parasitic capacitance formed by the pixel electrode of the first pixel 161 and the current gate line is Cgs1; the voltage values of the first low level and the third low level are V′GL, the voltage value of the high level is VGH, and the voltage value of the second low level is VGL;

Cst1=(VGH−VGL)*Cgs1/(VGL−V′GL).

At \textcircled{1}, Vpixel=Vdata

At \textcircled{2}, ΔV1=ΔV′1+ΔV″1

ΔV′1=(VGH−V′GL)*Cgs1/(Cgs+Cst+Clc)

ΔV″1=(V′GL−VGH)*Cst1/(Cgs+Cst+Clc)

At \textcircled{3}, ΔV2=ΔV′2+ΔV″2

ΔV′2=(V′GL−VGL)*Cgs1/(Cgs+Cst+Clc)

ΔV″2=(VGH−V′GL)*Cst1/(Cgs+Cst+Clc)

At \textcircled{4}, ΔV3=(V′GL−VGL)*Cst1/(Cgs+Cst+Clc)

In order to reduce flickers caused by kickback, it is set that Cst1=(VGH−VGL)*Cgs1/(VGL−V′GL), to form a correct loop, eliminate the influence of the kickback voltage and avoid flickers.

A storage capacitance formed by overlapping the second overlap region 180 of the second pixel 162 with the next gate line 140 is Cst2, a pixel capacitance of the second pixel 162 is Clc2, and a parasitic capacitance formed by the pixel electrode of the second pixel 162 and the current gate line is Cgs2; the voltage values of the first low level and the third low level are V′GL, the voltage value of the high level is VGH, and the voltage value of the second low level is VGL;

Cst2=(VGH−VGL)*Cgs2/(VGL−V′GL).

At \textcircled{1}, Vpixel=Vdata

At \textcircled{2}, ΔV1=ΔV′1+ΔV″1

ΔV′1=(VGH−V′GL)*Cgs2/(Cgs+Cst+Clc)

ΔV″1=(V′GL−VGL)*Cst2/(Cgs+Cst+Clc)

At \textcircled{3}, ΔV2=(V′GL−VGL)*Cgs2/(Cgs+Cst+Clc).

In order to reduce flickers caused by kickback, it is set that Cst2=(VGH−VGL)*Cgs1/(VGL−V′GL), to form a correct loop, eliminate the influence of the kickback voltage and avoid flickers. In this solution, the same data line 130 is connected to two adjacent pixels 150 to form a pixel group 160, and the same data voltage is input for driving, and two adjacent pixels 150 are respectively connected to different gate lines 140, reducing the influence of the load.

In one or more embodiments, the same data line 130 is connected to two adjacent pixels 150 to form a pixel group 160, and the pixel group 160 includes a first pixel 161 and a second pixel 162 connected to different gate lines 140. As shown in FIG. 4, gate lines 140 connected to the first pixels 161 are first gate lines, the first gate lines includes first main gate lines 146 and first auxiliary gate lines 144, gate lines 140 connected to the second pixels 162 are second gate lines, and the second gate lines include second main gate lines 145 and second auxiliary gate lines 143; the first auxiliary gate lines 144 and the pixel electrode of the second pixel 162 corresponding to the second main gate lines 145 form a second overlap region 180, and the second auxiliary gate lines 143 and the pixel electrode of the first pixel 161 corresponding to the first main gate lines 146 form a first overlap region 170. In this solution, two adjacent pixels 150 are set to be connected to the same data line 130; in the architecture of different gate lines 140, the auxiliary gate lines 142 are set, weakening the parasitic capacitance formed by the data lines 130 and the pixel electrode.

In one or more embodiments, a first safety distance is arranged both between the auxiliary gate line 142 and the pixel electrode of the first pixel 161 corresponding to the current main gate line 141, and between the auxiliary gate line 142 and the pixel electrode of the second pixel 162 corresponding to the previous main gate line 141.

In this solution, the first safety distance is set to be a preset threshold, and the preset threshold is obtained by those skilled in the art through experiment or related data. This solution is feasible within the preset threshold, and cannot be implemented if the distance exceeds the preset distance, an electric field would be generated between the pixel electrode and the auxiliary gate line 142; if the distance is too close, the generated electric field is stronger, to affect the transmission of a data voltage signal, causing unstable voltage to affect the display of picture; and setting a safety distance can prevent the influence of the electric field.

In one or more embodiments, a second safety distance is arranged between the auxiliary gate line 142 and corresponding data line 130. In this solution, the auxiliary gate lines 142 and the data lines 130 are arranged in parallel, and the second safety distance is a preset threshold. The preset threshold is obtained by those skilled in the art through experiment or related data. This solution is feasible within the preset threshold, and cannot be implemented if the distance exceeds the preset distance. Setting a safety distance can reduce the crosstalk phenomenon, preventing influence to the picture quality of the display panel 110.

As shown in FIGS. 1 and 6, as another embodiment of the present application, disclosed is a driving method, applied to the display panel 110. The display panel 110 includes a plurality of pixels 150 formed by intersecting a plurality of data lines 130 with a plurality of gate lines 140; the driving method includes a step of outputting a gate driving signal to a corresponding gate line of the display panel 110; where a signal period of the gate driving signal includes a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down tune and the second pull-down time; and a voltage value of the second low level is less than a voltage value of the first low level.

In this solution, due to the parasitic capacitance Cgs between the gate line 140 and the pixel electrode, when elements are turned off after the pixels 150 are charged, the change of the gate voltage redistributes a liquid crystal capacitance and storage capacitance charge of the pixels through the parasitic capacitance Cgs, so that a kickback phenomenon occurs to the voltage of the charged original pixels 150. In order to improve the kickback phenomenon of the voltage, a period of each gate driving signal includes four time periods, respectively a hold time, a first pull-down time, an open time, and a second pull-down time; the open time is between the first pull-down time and the second pull-down time, and the durations thereof are equal; the voltage value of the second low level corresponding to the first pull-down time is equal to the voltage value of the third low level corresponding to the second pull-down time and is less than the voltage value of the first low level corresponding to the hold time, to form a correct loop to eliminate the kickback phenomenon of the voltage of the charged original pixels 150, thereby reducing or even eliminating the flicker problem of liquid crystal display.

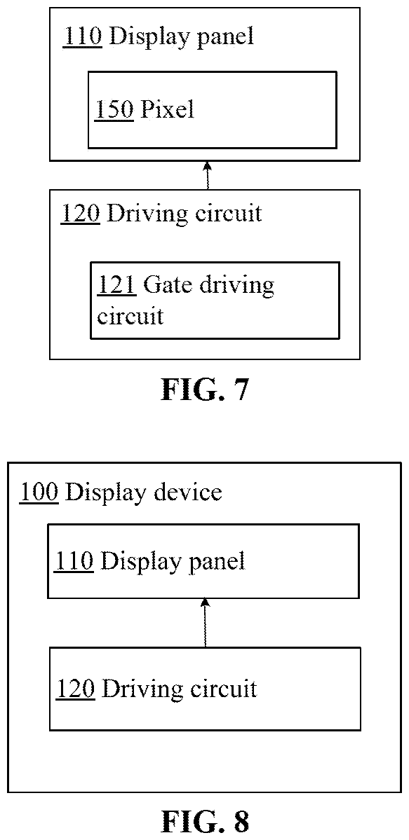

As shown in FIG. 7, as another embodiment of the present application, disclosed is a driving circuit 120. The driving circuit 120 drives any display panel 110 as stated above. The driving circuit 120 includes: a gate driving circuit 121 configured to output a gate driving signal to a corresponding gate line of the display panel 110; where a signal period of the gate driving signal includes a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down time and the second pull-down time; and a voltage value of the second low level is less than a voltage value of the first low level.

In this solution, the driving circuit 120 is configured to drive the display panel 110 of the present application; the gate driving circuit 121 in the driving circuit 120 outputs a signal to a corresponding gate line of the display panel 110, and outputs a corresponding signal to turn on a corresponding gate line; the gate driving signal of the current driving signal corresponds to the first pull-down time when the gate driving signal of the previous gate line corresponds to the open time; and the gate driving signal of the current gate line corresponds to the open time when the gate driving signal of the previous gate line corresponds to the second pull-down time; a period of the gate driving signal is divided into four time periods, respectively a hold time, a first pull-down time, an open time, and a second pull-down time; the open time is between the first pull-down time and the second pull-down time, and the durations thereof are equal; the voltage value of the second low level corresponding to the first pull-down time is equal to the voltage value of the third low level corresponding to the second pull-down time and is less than the voltage value of the first low level corresponding to the hold time, to form a correct loop to solve the flicker problem caused by the kickback voltage.

As shown in FIG. 8, as another embodiment of the present application, disclosed is a display device 100, including the display panel 110 and the driving circuit 120.

It should be noted that the definitions of steps involved in this solution are not intended to limit the sequence of steps without affecting the implementation of the specific solution. The preceding steps can be executed anteriorly, and can also be executed posteriorly, or even can be executed simultaneously. As long as this solution can be implemented, it should be considered as the scope of protection of the present application.

The technical solution of the present application can be widely applied to various display panels, such as a Twisted Nematic (TN) display panel, an In-Plane Switching (IPS) display panel, a Vertical Alignment (VA) display panel, and a Multi-domain Vertical Alignment (MVA) display panel, and certainly, may also be other types of display panels, such as an OLED display panel, if appropriate.

The contents above are detailed descriptions of the present application in conjunction with optional specific embodiments, and the specific implementation of the present application is not limited to these descriptions. It will be apparent to those skilled in the art that various simple deductions or substitutions may be made without departing from the spirit of the present application, and should be considered to be within the scope of protection of the present application.

What is claimed is:

1. A display panel, comprising:
a plurality of data lines;
a plurality of gate lines intersected with the data lines; and
a plurality of pixels respectively driven by corresponding data lines and gate lines, each of the plurality of pixels comprise a corresponding pixel electrode;
wherein the pixel electrode of the pixel overlaps with adjacent another gate line to form an overlap region.

2. The display panel according to claim 1, wherein the gate lines comprise main gate lines and auxiliary gate lines conducted to each other, and the main gate lines are intersected with the data lines.

3. The display panel according to claim 2, wherein the auxiliary gate lines and the data lines are arranged in parallel.

4. The display panel according to claim 3, wherein a same gate line is connected to two adjacent pixels to form a pixel group, and the pixel group comprises a first pixel and a second pixel connected to different data lines;
wherein a pixel electrode of the first pixel of the pixel group overlaps with a previous gate line to form a first overlap region, and a pixel electrode of the second pixel of the pixel group overlaps with a next gate line to form a second overlap region.

5. The display panel according to claim 3, wherein the auxiliary gate lines comprise first auxiliary gate lines and second auxiliary gate lines, the first auxiliary gate lines and the pixel electrode of the second pixel corresponding to the previous gate line form a first overlap region, and the second auxiliary gate lines and the pixel electrode of the first pixel corresponding to the next gate line form a second overlap region.

6. The display panel according to claim 3, wherein the same data line is connected to two adjacent pixels to form a pixel group, and the pixel group comprises a first pixel and a second pixel connected to different gate lines;
wherein the pixel electrode of the first pixel of the pixel group overlaps with the previous gate line to form a first overlap region, and the pixel electrode of the second pixel of the pixel group overlaps with the next gate line to form a second overlap region.

7. The display panel according to claim 6, wherein the same data line is connected to two adjacent pixels to form a pixel group, and the pixel group comprises a first pixel and a second pixel connected to different gate lines;
gate lines connected to the first pixels are first gate lines, the first gate lines comprises first main gate lines and first auxiliary gate lines, gate lines connected to the second pixels are second gate lines, and the second gate lines comprise second main gate lines and second auxiliary gate lines;
the first auxiliary gate lines and the pixel electrode of the second pixel corresponding to the second main gate lines form a first overlap region, and the second auxiliary gate lines and the pixel electrode of the first pixel corresponding to the first main gate lines form a second overlap region.

8. The display panel according to claim 3, wherein a first safety distance is arranged both between the auxiliary gate line and the pixel electrode of the first pixel corresponding to the current main gate line, and between the auxiliary gate line and the pixel electrode of the second pixel corresponding to the previous main gate line.

9. The display panel according to claim 3, wherein a second safety distance is arranged between the auxiliary gate line and corresponding data line.

10. A driving method, applied to a display panel, the display panel comprises:
a plurality of data lines;
a plurality of gate lines intersected with the data lines; and
a plurality of pixels respectively driven by corresponding data lines and gate lines, each of the plurality of pixels comprise a corresponding pixel electrode;
the driving method comprises a step of outputting a gate driving signal to a corresponding gate line of the display panel;
wherein a signal period of the gate driving signal comprises a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down time and the second pull-down time; and a voltage value of the second low level is less than a voltage value of the first low level.

11. The driving method according to claim 10, wherein the first pull-down time is before the open time, and a signal period of the gate driving signal further comprises a second pull-down time after the open time; the gate driving signal is in a third low level within the second pull-down time, and a voltage value of the third low level is less than the voltage value of the first low level.

12. The driving method according to claim 11, wherein the first pull-down time and the open time are equal in duration, and when a gate driving signal of a previous gate line corresponds to the open time, a gate driving signal of a current gate line corresponds to the first pull-down time.

13. The driving method according to claim 12, wherein the open time and the second pull-down time are equal in duration, and when the gate driving signal of the previous gate line corresponds to the second pull-down time, the gate driving signal of the current gate line corresponds to the open time.

14. The driving method according to claim 12, wherein the voltage value of the second low level is equal to the voltage value of the third low level.

15. The driving method according to claim 13, wherein the each pixel comprises a pixel electrode, a same gate line is connected to two adjacent pixels to form a pixel group, and the pixel group comprises a first pixel and a second pixel connected to different data lines;
wherein a pixel electrode of the first pixel of the pixel group overlaps with the previous gate line to form a first overlap region, the area of the first overlap region is S1, a storage capacitance formed by overlapping the first overlap region of the first pixel with the previous gate line is Cst1, a pixel capacitance of the first pixel is Clc1, and a parasitic capacitance formed by the pixel electrode of the first pixel and the current gate line is Cgs1;
the voltage values of the first low level and the third low level are V′GL, the voltage value of the high level is VGH, and the voltage value of the second low level is VGL;
Cst1=(VGH−VGL)*Cgs1/(VGL−V′GL).

16. The driving method according to claim 15, wherein the each pixel comprises a pixel electrode, a same gate line is connected to two adjacent pixels to form a pixel group, and the pixel group comprises a first pixel and a second pixel connected to different data lines;
a pixel electrode of the second pixel of the pixel group overlaps with a next gate line to form a second overlap region, the area of the second overlap region is S2, a storage capacitance formed by overlapping the second overlap region of the second pixel with the next gate line is Cst2, a pixel capacitance of the second pixel is Clc2, and a parasitic capacitance formed by the pixel electrode of the second pixel and the current gate line is Cgs2;
the voltage values of the first low level and the third low level are V′GL, the voltage value of the high level is VGH, and the voltage value of the second low level is VGL;
Cst2=(VGH−VGL)*Cgs2/(VGL−V′GL).

17. A driving circuit for driving a display panel, the display panel comprises:
a plurality of pixels formed by intersecting a plurality of data lines with a plurality of gate lines;
each of the plurality of pixels comprises a pixel electrode;
wherein the pixel electrode of the pixel overlaps with adjacent another gate line to form an overlap region;
the driving circuit comprises:
a gate driving circuit configured to output a gate driving signal to a corresponding gate line of the display panel;
wherein a signal period of the gate driving signal comprises a hold time, a first pull-down time, an open time, and a second pull-down time; a duration of the first pull-down time, a duration of the open time, and a duration of the second pull-down time are equal; the gate driving signal is in a first low level within the hold time, in a high level at the open time, and in a second low level within the first pull-down time and the second pull-down time; and a voltage value of the second low level is less than a voltage value of the first low level.

18. The driving circuit according to claim 17, wherein the first pull-down time and the open time are equal in duration, and when a gate driving signal of a previous gate line corresponds to the open time, a gate driving signal of a current gate line corresponds to the first pull-down time.

19. The driving circuit according to claim 18, wherein the open time and the second pull-down time are equal in duration, and when the gate driving signal of the previous gate line corresponds to the second pull-down time, the gate driving signal of the current gate line corresponds to the open time.
